(19) United States
(12) Patent Application Publication
(10) Pub. No.: US 2018/0276007 A1
(43) Pub. Date: Sep. 27, 2018

(54) METHOD FOR MONITORING INFORMATION TO BE DISPLAYED ON A SCREEN, DEVICE AND SYSTEM

(71) Applicant: Rohde & Schwarz GmbH & Co. KG, Munich (DE)

(72) Inventors: Josef Fuerst, Munich (DE); Bjoern Schmid, Munich (DE)

(73) Assignee: Rohde & Schwarz GmbH & Co. KG, Munich (DE)

(21) Appl. No.: 15/466,683

(22) Filed: Mar. 22, 2017

(51) Int. Cl. G06F 9/44; G06F 17/27

(52) U.S. Cl. CPC G06F 9/4448; G06F 17/275

(57) ABSTRACT

A method for monitoring information to be displayed on a screen is described. The information to be displayed on said screen comprises text information. The information to be displayed is processed by a language identification unit such that the language of said text information is determined. Further, a device and a system are described.

### FIELD OF THE DISCLOSURE

Embodiments of the present disclosure relate generally to a method for monitoring information to be displayed on a screen, and a device as well as a system for monitoring information to be displayed on a screen of a device.

### BACKGROUND

Signals comprising video data are typically transmitted via telecommunication or broadcasting systems such as television or the internet, for instance as television signals (TV signals) or streams that can be watched on a customer device. Generally, video data comprises image data as well as audio data. Moreover, the signals transmitted may comprise additional information with regard to the video data wherein this information relates to content being additionally displayed on the screen of the customer device. For instance, this additional information comprises text information such as subtitles or closed captions that are embedded in the signals transmitted. According to the European standard, subtitles are used wherein a German translation of an English speaker (English audio data) may be provided. Moreover, subtitles can be used for describing images displayed on the screen, in particular for hearing-impaired consumers. According to the U.S. standard, closed captions are used for additionally providing text information that is displayed on the screen of the customer device. The closed captions additionally allow to position the text information on the screen, for instance near a speaker like a speech bubble.

Usually, the language of the text information is selected by the customer manually according to his preference. The customer may select between different languages offered for the subtitles, for instance German, French or English, wherein the original audio data being in another language is subtitled by the preferred language selected manually.

### SUMMARY

Thus, a need exists for a customer-friendly possibility to provide a desired language of text information additionally displayed on the screen of a customer device.

To address this need, among others, the present disclosure provides examples of a method for monitoring information to be displayed on a screen. The information to be displayed on the screen comprises text information. The information to be displayed is processed in one embodiment by a language identification unit such that the language of the text information is determined.

Accordingly, it is possible to detect the language of the text information that will be displayed on the screen, for instance at least one of a subtitle and a closed caption. As the language of the text information is determined, the language determined may be taken into account for further processing, for example, for matching purposes with regard to other information being part of the transmission signals. The transmission signals may comprise the text information, audio data, image data and/or video data encompassing audio data and image data simultaneously. Therefore, the language used in the audio data, for example, the audio data encompassed in the video data, and the one determined from the text information may be compared with regard to matching purposes.

According to an aspect, the language of the text information is determined automatically. Thus, no human interaction of the customer is necessary in order to obtain the desired language for the text information that will be displayed on the screen.

According to an embodiment, the information to be displayed comprises subtitles. Subtitles are typically used in Europe for additionally displaying text information on the screen of the customer device, such as a television, monitor, etc. Thus, the method for monitoring information to be displayed is applicable with regard to the European standard.

In some embodiments, the subtitles are converted into a machine-readable text format by using, for example, an optical character recognition. Usually, the subtitles are transmitted as pictures that cannot be read by a machine automatically. Thus, the information of the pictures, in particular the text information encompassed, is converted by an optical character recognition unit in order to obtain text information that can be evaluated automatically by a machine such as a signal generation device used for generating the transmission signals.

According to another aspect, the information to be displayed comprises closed captions. Thus, the method disclosed herein is also applicable with regard to the US standard using closed captions for displaying additional text information on the screen of the customer device, such as a television, monitor, etc. As the closed captions already deliver a machine-readable text format by default, it is not necessary to apply an optical character recognition on embodiments concerning closed captions.

An aspect of the disclosure provides that the language determined is compared with a language information. The language information may relate to the language of audio data being encompassed by the transmission signals, for example, the audio data being part of the video data. The comparison will be done automatically by a machine such that no human interaction is necessary. The language information may be decoded or provided directly. Further, the language information may relate to another input, for instance, a predefined language on the generation side or the customer side or both.

For example, the language of the text information (language determined) and the one of the audio data (language information) may be adapted on the generation side such that a matching is obtained while generating the transmission signals. The matching may be obtained by providing one and the same language for the different data/information transmitted via the transmission signals. Alternatively, the matching may be obtained while transmitting different languages for the audio data and the text information wherein this setting is predefined, in particular on the generation side. For instance, the transmission signals are broadcasted or streamed that comprise English audio data and Swedish text information wherein this combination relates to a predefined matching that is desired for a certain country or area, in particular Sweden. Accordingly, the predefined setting may relate to the country or area being used for broadcasting/streaming in general.

Moreover, the comparison may be performed on the customer's side. Accordingly, different data may be transmitted via the transmission signals wherein the different data relate to different languages for the audio data and/or the text information. Thus, the customer may set its customer device appropriately such that the predefined settings will be taken into account ensuring that these predefined settings are met. Hence, the languages for the audio data and the text information additionally displayed meet the predefined settings of the user while using the appropriate data automatically, in particular by the customer device.

For instance, the language information relates to a predefined language setting. The predefined language setting may be done by the customer at its customer device. The customer may set the language for the subtitles/closed captions. Accordingly, it is verified if the language of the text information corresponds to the language desired that has been set by the customer previously (predefined language setting).

Alternatively, the predefined language setting is done on the signal generation side. For instance, the predefined language setting depends on the country or area that shall receive the transmission signals. The comparison unit verifies if the language of the text information corresponds to the desired language, in particular with respect to the language of the audio data. As already mentioned above, the predefined language setting may relate to one and the same language for the audio data and the text information or different languages for the audio data and the text information depending to the country/area.

Further, the language information may correspond to the signaled language. The signaled language relates to the language that is announced in the transmission signals, e.g., the language of the audio data. Thus, this comparison is done at the customer side, in particular automatically. Provided that different audio data and/or text information data are transmitted by the signal with regard to different languages, it is verified if the language of the audio data (signaled language) matches with the language of the text information that is additionally displayed. Otherwise, the languages are changed such that a matching is provided.

According to one embodiment, the comparison takes place on the generation side of a transmission signal comprising at least the information to be displayed wherein the comparison result is filled in the transmission signal. The corresponding information, particularly the result of the comparison, is filled in the transmission signal, for instance, in the transport stream comprising broadcasting and/or streaming data. Accordingly, the comparison result, particularly the result of language detection, obtained on generation side is stamped in the transport stream. Therefore, the result of language detection is retrievable as it is encompassed in the transmission signal.

On the generation side, the language information may be adapted with regard to the language detected or vice versa. Thus, the signaled language, namely the language of the audio data, may be adapted appropriately with respect to the language determined (the language of the text information). Alternatively, the text information is adapted appropriately with regard to the language information, namely the language of the audio data. Generally, this ensures that transmission signals are generated that have matching languages with regard to the language of the text information and the language of the audio data. Hence, these transmission signals are forwarded to the customers, for instance, broadcasted or streamed. Thus, it is prevented that transmission signals are transmitted having wrong languages with regard to the text information and/or the audio data.

Furthermore, an alarm may be output in case of a mismatch between the language determined and the language information. This alarm may be output on the generation side or at the customer side. Generally, the alarm indicates that an error occurs with regard to the languages provided. This occurring error may be remedied automatically by an appropriate device, manually by the customer on the customer side or manually by staff on the generation side. For instance, a signal generation device on the generation side may select other data for the audio data and/or the text information ensuring a matching such that no alarm is output during the comparison. On the customer side, a customer device may select other data provided that relate to a different language of the text information and/or the audio data.

The information to be displayed may be displayed on a screen. Thus, the information that is evaluated is displayed on the customer side, for instance, on a screen of a television or any other suitable device.

In some embodiments, the screen is part of a television, a mobile device or a computer. These devices can be used for displaying video data that are encompassed in the transmission signals forwarded to the customer.

Generally, the information to be displayed may be associated to video data being also displayed on the screen. As already mentioned, the information to be displayed may comprise at least one of closed caption or subtitle wherein this information is directed to the video data that is displayed on the screen at customer side, for instance on a television or a computer screen.

In accordance with another aspect of the disclosure, a device is provided that comprises a language identification unit configured to process information to be displayed on a screen. The information to be displayed comprises text information. The language identification unit is further configured to determine the language of the text information. The language identification unit identifies the language of the additional text information such that an automatic language identification can be performed. The device may be a customer device used on the customer side or a signal generation device used on the generation side for generating transmission signals such as a stream or a broadcasting signal, for instance, a television signal.

According to an aspect, the device comprises an optical character recognition unit that is configured to convert the information to be displayed into a machine-readable text format. For instance, the information to be displayed is directed to subtitles being pictures. Thus, the optical character recognition ensures that the information of the pictures can be converted into a machine-readable text format such that the language identification unit is enabled to perform an identification step automatically.

Further, the device may comprise a comparison unit that is configured to compare the language determined with a language information. The language determined relates to the language of the text information whereas the language information may relate to the predefined language setting or the language signaled being already forwarded to the user via the transmission signals.

Another aspect provides that the comparison unit is configured to output an alarm in case that a mismatch is detected during the comparison. Thus, the device may remedy the detected error in an automatic manner, in particular the signal generation device or the customer device. Further, the error occurred may be remedied manually, for instance, by the customer or a staff on the signal generation side.

In some embodiments, the device may be used on the generation side. Thus, the language identification as well as the comparison is done on the generation side such that the language information may be adapted with regard to the language determined of the additional information to be displayed on the screen or vice versa. Hence, it is ensured that transmission signals are generated that have matching languages with regard to the audio data and the additional text information.

According to an embodiment, the device comprises a decoder that is configured to decode language information from a transmission signal. The decoder may be used at the customer side as it decodes the language information of the transmission signal that has been broadcasted/streamed, in particular the language of the audio data within the transmission signal. Thus, the language of the signals, in particular the audio data, is automatically determined by using the decoder. Further, the language information decoded may be forwarded to the comparison unit that compares the language information decoded (signaled language) and the language of the additional information to be displayed on the screen. A matching of these languages can be verified wherein an adaption of the languages is done provided that an error is identified while verifying the languages of the signaled signal and the language of the text information.

Generally, the device according to some embodiments may be configured to perform one or more methods as mentioned above. As already mentioned, the devices of the disclosure may be a signal generation device or a customer device.

Further, a system is provided for monitoring information to be displayed on a screen of a device, wherein the system is configured to perform one or more methods as mentioned above. The system relates to the whole broadcasting/streaming system that comprises the generation side used for generating the transmission signals and the customer side used for receiving these transmission signals.

For instance, the system comprises a customer device and a signal generation device, at least one of the signal generation device and the customer device being formed as a device as mentioned above. The customer device may comprise a decoder that is used for decoding language information from the transmission signal being generated by the signal generation device used at the generation side.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a schematic overview of a system according to an aspect of the disclosure that is used for performing a method according to the disclosure; and

FIG. 2 shows a schematic overview of a customer device according to an aspect of the disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

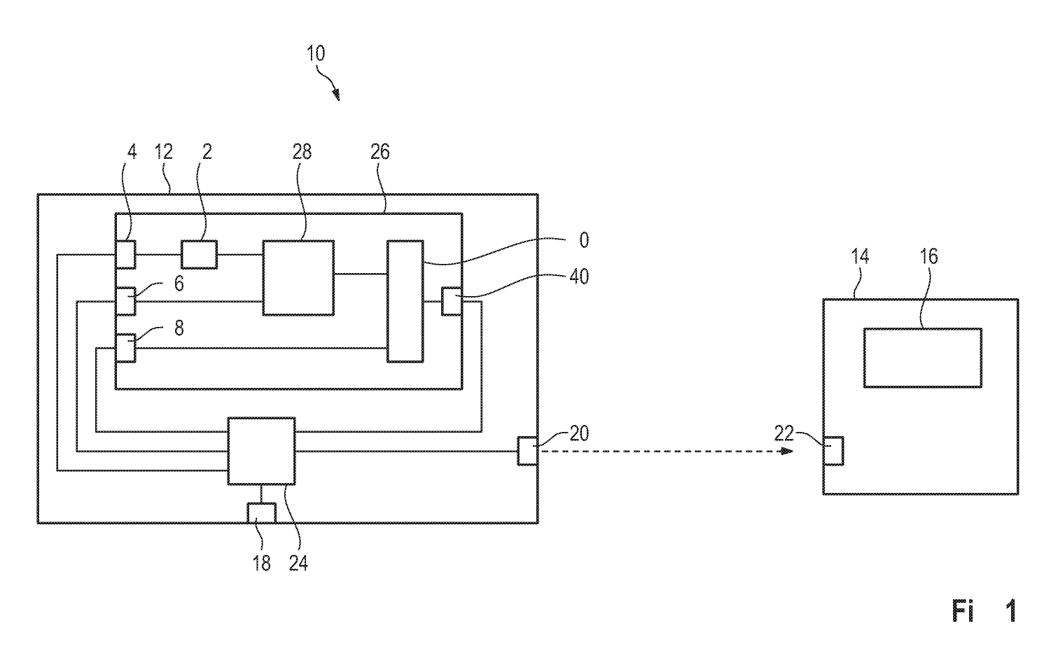

In FIG. 1, a system 10 for monitoring information to be displayed is shown. The system 10 comprises a signal generation device 12 and a customer device 14 that has a screen 16 for displaying video data as well as information to be displayed, in particular text information. The video data as well as the text information are forwarded to the customer device 14 via the signal generation device 12 as will be described hereinafter.

In the shown embodiment, the signal generation device 12 comprises an input 18 for receiving data that are used to generate a transmission signal forwarded to the customer device 14 via an output 20 that interacts with an input 22 of the customer device 14 for transmission purposes.

In addition, the signal generation device 12 has a processing unit 24 that processes the data fed to the input 18 wherein the processing unit 24 forwards the data to an internal language verifying unit 26.

The language verifying unit 26 has a language identification unit 28 and a comparison unit 30 being connected with each other. In general, the language identification unit 28 is configured to process the information to be displayed on the screen 16 of the customer device 14. The data related to this information is also fed to the signal generation device 12 via the input 18.

Further, the signal generation device 12, in particular its language verifying unit 26, has an optical character recognition unit 32 that is configured to convert information to be displayed on the screen 16 of the customer device 14 into a machine-readable text format such that the language identification unit 28 is enabled to automatically determine the language of the text information encompassed in the information to be displayed.

As shown in FIG. 1, the language verifying unit 26 has three inputs 34, 36, 38 that are connected with the processing unit 24. Accordingly, the processing unit 24 may forward three different data portions of the transmission signal to be generated wherein these data portions are forwarded to the different inputs 34-38. Hence, the inputs 34-38 are used for receiving different data portions that are processed by the signal generation device 12 at generation side in order to generate the transmission signals that are forwarded to the customer, for instance broadcasted or streamed. Accordingly, the customer device 14 may receive the video data and the additional information such as subtitles or closed captions wherein the video data and the information are encompassed in the transmission signals generated.

For instance, the first input 34 is configured to receive information to be displayed that comprises subtitles according to the European standard, whereas the second input 36 is configured to receive information to be displayed that comprises closed captions according to the American standard.

The first and the second inputs 34, 36 are connected with the language identification unit 28 that is configured to determine the language of said information, in particular the language of the data representing the subtitles fed to the first input 24 as well as the one of the data representing the closed captions fed to the second input 36.

Further, the optical character recognition unit 32 is disposed between the first input 34 and the language identification unit 28. This ensures that the text information, in particular the data representing the subtitles, is converted by the optical character recognition unit 32 into a machine-readable text format such that the language identification unit 28 is enabled to automatically determine the language of the subtitles processed.

Generally, the language identification unit 28 outputs a certain language, for instance German, English or French depending on the language identified in the text information. The output of the language identification unit 28 is directly connected to the comparison unit 30 that has another input that is configured to receive a language information. On generation side, the language information may correspond to a predefined language setting which means the language of the audio data that will be used by the signal generation device 12 for generating the transmission signals.

The comparison unit 30 compares the language determined of the text information and the language information received wherein an alarm is output in case that a mismatch is detected. This output signal of the comparison unit 30 is forwarded via an output 40 of the language verifying unit 26 being connected with the processing unit 24.

The occurring error can be remedied automatically by the signal generation device 12, in particular its processing unit 24, while adapting at least one of the language information and the language of the text information appropriately, in particular the respective data. Thus, the different languages are checked prior to generating the transmission signals on generation side. For instance, the language information, in particular the language of the audio data, is adapted with regard to the language of the text information such that both languages match with each other.

In general, the matching may relate to using one and the same language for the audio data and the text information. Alternatively, the matching may relate to a certain combination being predefined, for instance English audio data and Danish text information.

Then, the transmission signal is generated appropriately such that the signal can be forwarded to the customer device 14 via the output 20 interacting with the input 22 of the customer device 14. Hence, transmission signals are output that encompass video data and additional information wherein the video data comprises audio data that relates to the language information.

On customer side, the video data and the additional information are displayed on the screen 16 of the customer device 14 wherein the language of the additional information matches with the language information, in particular the language of the audio data encompassed in the video data.

As the languages are verified prior to the generation of the transmission signals, the text information or the comparison result (the result of language detection) may be stamped in the transport stream such that the corresponding information can be forwarded appropriately. Thus, the corresponding information is filled in the transmission signal ensuring that it is visible or at least retrievable.

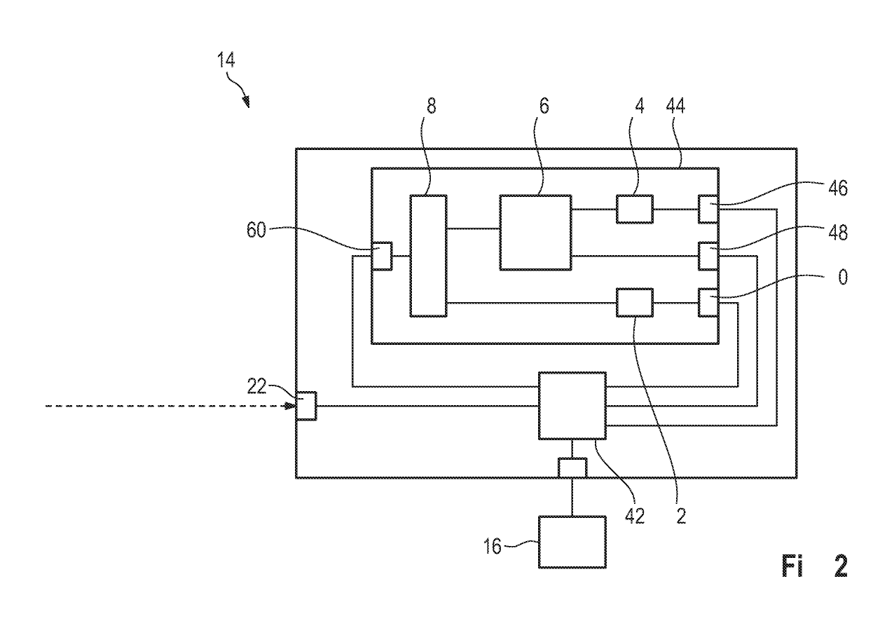

In FIG. 2, a customer device 14 according to a certain embodiment is schematically shown.

The customer device 14 receives a transmission signal forwarded from the signal generator device 12 as shown in FIG. 1.

The received transmission signal is internally processed by using a processing unit 42 that disassembles the transmission signal into its components that have been merged previously for generating the transmission signal. The different data streams are forwarded to a language verifying unit 44 comprising three inputs 46, 48, 50 that are configured to receive data streams relating to text information formed by subtitles, text information formed by closed captions and video data, respectively.

The language verifying unit 44 has a decoder 52 that is configured to decode language information from the transmission signal received, in particular the data stream relating to the video data. Particularly, the decoder 52 has an integrated language identification unit that is configured to determine the language of the language information decoded from the transmission signal. In general, the decoder 52 is configured to determine the language information that corresponds to the signaled language being forwarded to the customer device 14.

The language verifying unit 44 of the customer device 14 also comprises an optical character recognition unit 54 that is configured to convert the text information, in particular the subtitles, into a machine-readable text format such that a subsequent language identification unit 56 is enabled to automatically determine the language of the text information. The language identification unit 56 also receives the data stream relating to the text information of closed caption.

Afterwards, the language identified by the language identification unit 56 and the decoder 52 are forwarded to a subsequent comparison unit 58 that compares the language determined of the text information and the language information decoded wherein an alarm is output in case that a mismatch is detected. This output signal of the comparison unit 58 is forwarded via an output 60 of the language verifying unit 44 being connected with the processing unit 42.

On the customer side, the language information may correspond to a predefined language setting which means the language preferred by the customer and set at the customer device 14.

The occurring error can be remedied automatically by the customer device 14, in particular its processing unit 42, while adapting at least one of the language information and the language of the text information appropriately, in particular the respective data. Therefore, the transmission signal may provide at least several data streams for at least one of the language information (video/audio data) and the language of the text information. For instance, the language information, in particular the language of the audio data, is adapted with regard to the language of the text information such that both languages match with each other.

In general, the matching may relate to using one and the same language for the audio data and the text information. Alternatively, the matching may relate to a certain combination being predefined, for instance English audio data and Danish text information.

For instance, the customer device 14 automatically selects other data streams representing the information to be displayed on the screen 16 wherein the data correspond to the language information decoded from the signal received or to a predefined setting of the customer with regard to his preferred language for text information to be displayed, in particular for subtitles or closed captions.

Generally, the information to be displayed may comprise closed captions, subtitles and other content that can be displayed additionally to the video data on the display 16 of the customer device 14.

The system 10 as well as the method may also be used in cinema applications.

The transmission signals in some embodiments may be transmitted or otherwise forwarded via at least one of DVB, DAB, OTT and ATSC technology. Other audio/video data transmission technologies as well as future developed transmission technologies may also be practiced with one or more embodiments disclosed herein.

Furthermore, the method and system can be used for live transmission such that the languages are adapted live, in particular on at least one of the customer side and the generation side.

Thus, a method, a system 10 and a customer device 14 are provided that ensure providing the right information with regard to the language in an easy manner as no manual interaction is required anymore.

Certain embodiments disclosed herein utilize circuitry in order to implement protocols, methodologies or technologies disclosed herein, operably couple two or more components, generate information, process information, encode signals, decode signals, transmit and/or receive signals, etc. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

In an embodiment, circuitry includes one or more ASICs having a plurality of predefined logic components. In an embodiment, circuitry includes one or more FPGA having a plurality of programmable logic components. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

In an embodiment, circuitry includes a baseband integrated circuit or applications processor integrated circuit or a similar integrated circuit in a server, a broadcast/streaming device, such as for example a cellular network device, an OTA network device, an OTT network device, a satellite network device, an interne protocol device, etc., and other network devices, or other computing devices. In an embodiment, circuitry includes one or more remotely located components. In an embodiment, remotely located components are operably coupled via wireless communication. In an embodiment, remotely located components are operably coupled via one or more receivers, transmitters, transceivers, or the like.

In an embodiment, circuitry includes one or more memory devices that, for example, store instructions or data. Non-limiting examples of one or more memory devices include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of one or more memory devices include Erasable Programmable Read-Only Memory (EPROM), flash memory, or the like. The one or more memory devices can be coupled to, for example, one or more computing devices by one or more instructions, data, or power buses.

In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more user input/output components that are operably coupled to at least one computing device to control (electrical, electromechanical, software-implemented, firmware-implemented, or other control, or combinations thereof) at least one parameter associated with the device for displaying information.

In an embodiment, circuitry includes a computer-readable media drive or memory slot configured to accept signal-bearing medium (e.g., computer-readable memory media, computer-readable recording media, or the like). In an embodiment, a program for causing a system or device to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method for monitoring information to be displayed on a screen, said information to be displayed on said screen comprising text information, the method comprising:
processing said information to be displayed by a language identification unit such that the language of said text information is determined automatically;
comparing said language of said text information determined from said processing with a language information, said comparing taking place on a generation side of a transmission signal comprising at least said information to be displayed.

2. (canceled)

3. The method according to claim 1, wherein said information to be displayed comprises subtitles.

4. The method according to claim 3, wherein said subtitles are converted into a machine-readable text format by using an optical character recognition.

5. The method according to claim 1, wherein said information to be displayed comprises closed captions.

6. (canceled)

7. The method according to claim 1, wherein said language information relates to a predefined language setting.

8. The method according to claim 1, wherein said language information corresponds to the signaled language.

9. The method according to claim 1, wherein said comparison result is filled in the transmission signal.

10. The method according to claim 1, further comprising outputting an alarm in case of a mismatch between said language of said text information determined from said processing and said language information.

11. The method according to claim 1, wherein said information to be displayed is displayed on a screen.

12. The method according to claim 1, wherein said information to be displayed is associated to video data being also displayed on said screen.

13. An apparatus, comprising:
a language identification unit configured to process information to be displayed on a screen, said information to be displayed comprising text information, said language identification unit being further configured to determine the language of said text information automatically; and
a comparator configured to compare said language determined with a language information,
wherein said apparatus is a signal generation device used on generation side for generating transmission signals.

14. The apparatus according to claim 13, further comprising an optical character recognition unit that is configured to convert said information to be displayed into a machine-readable text format.

15. (canceled)

16. The apparatus according to claim 13, wherein said comparison unit is configured to output an alarm in case that a mismatch is detected during the comparison.

17. The apparatus according to claim 13, wherein said device comprises a decoder that is configured to decode language information from a transmission signal.

18. The apparatus according to claim 13, further comprising:
a monitoring unit configured to monitor the information to be displayed on a screen.

19. A system for monitoring information to be displayed on a screen of a device, wherein said system comprises:
a customer device; and
a signal generation device, said signal generation device comprising a language identification unit that is configured to process information to be displayed on a screen, said information to be displayed comprising text information, said language identification unit being further configured to determine the language of said text information.

20. (canceled)
